(19) United States
(12) Patent Application Publication
(10) Pub. No.: US 2012/0162182 A1
(43) Pub. Date: Jun. 28, 2012

(54) FLAT PANEL DISPLAY DEVICE AND OPERATING VOLTAGE ADJUSTING METHOD THEREOF

(75) Inventors: Sung-Hui LIN, Hsin-Chu (TW); Pei-Chun Liao, Hsin-Chu (TW); Pin-Miao Liu, Hsin-Chu (TW)

(73) Assignee: AU OPTRONICS CORP., Hsinchu (TW)

(21) Appl. No.: 13/197,057

(22) Filed: Aug. 3, 2011

(30) Foreign Application Priority Data
Dec. 28, 2010 (TW) 099146401

(51) Int. Cl. G09G 5/00

(52) U.S. Cl. 345/212

(57) ABSTRACT

An exemplary operating voltage adjusting method for a flat panel display device including at least a first testing pixel is provided. In the operating voltage adjusting method, a plurality of testing operating voltages are provided. The at least a first testing pixel operative with the testing operating voltages in sequence then is enabled to be charged by a first specific data and a plurality of first data voltages stored in the at least a first testing pixel effected by the testing operating voltages respectively can be obtained. Afterwards, an operating voltage of the flat panel display device is determined according to states of the first data voltages in a testing period. Moreover, an exemplary structure of the flat panel display device also is provided.

### TECHNICAL FIELD

The disclosure relates to display technologies, and more particularly to a flat panel display device with an operating voltage adjusting function.

### BACKGROUND

Currently, as a flat panel display device such as a thin film transistor (TFT) liquid crystal display device, has advantages of high display quality, small size, light weight and wide applicability and thus is widely used in a mobile phone, a notebook computer, a desktop computer, and other consumer electronics products. Moreover, the flat panel display device has gradually replaced the traditional cathode ray tube (CRT) display device and become a mainstream display device.

However, as electrical properties of the thin film transistor in the flat panel display device such as film quality, defect and carrier mobility, are easily changed under different conditions such as temperature, humidity and/or product life cycle. These changes would cause insufficient charging or voltage leakage of pixel capacitor and therefore degrade the quality of display.

Existing improvement means for examples the increase of carrier mobility, the decrease of leakage current and the improvement of TFT reliability until now still could not achieve unsatisfactory panel reliability, and therefore are difficult to keep the display quality in a best condition in time.

### SUMMARY OF EMBODIMENTS

Accordingly, an operating voltage adjusting method in accordance with an embodiment is adapted to a flat panel display device including at least a first testing pixel. In the exemplary embodiment, the operating voltage adjusting method includes steps of: providing a plurality of testing operating voltages; enabling the at least a first testing pixel operative with the testing operating voltages in sequence to be charged by a first specific data; obtaining a plurality of first data voltages stored in the at least a first testing pixel effected/influenced by the testing operating voltages respectively; and determining an operating voltage of the flat panel display device according to states of the first data voltages in a specific period, e.g., an operating voltage testing period.

A flat panel display device in accordance with another embodiment includes: a plurality of data lines, a plurality of scan lines, a displaying area, a testing area, a memory, a detecting circuit and a power supply circuit. The data lines are for providing display data voltage signals. The displaying area includes a plurality of pixels. Each of the pixels is electrically coupled with a corresponding one of the scan lines and a corresponding one of the data lines and thereby subjected to the control of a voltage signal provided on the corresponding scan line to determine whether to receive the display data voltage signal from the corresponding data line. The testing area includes a first testing pixel electrically coupled to a corresponding one of the scan lines and a corresponding one of the data lines. The memory is for storing a plurality of testing operating voltages. The detecting circuit is electrically coupled to the memory and the first testing pixel, for obtaining first data voltages stored in the first testing pixel being charged under the effects of the testing operating voltages respectively, selecting one of the testing operating voltages stored in the memory as an operating voltage according to states of the first data voltages and storing the operating voltage in the memory. The power supply circuit is electrically coupled to the memory to acquire the operating voltage, for providing a power supply with the operating voltage to an electronic device of the flat panel display device for use during a first period (e.g., image display period) and providing power supplies with the respective testing operating voltages in sequence to the electronic device of the flat panel display device for use during a second period (e.g., operating voltage testing period). Herein, the electronic device may be a scan line driving circuit module for supplying voltage signals on the scan lines, or a common voltage driving circuit module for supplying a common voltage to the pixels.

### BRIEF DESCRIPTION OF THE DRAWINGS

The above embodiments of the disclosure will become more readily apparent to those ordinarily skilled in the art after reviewing the following detailed description and accompanying drawings.

FIG. 1 shows a schematic system architecture view of a flat panel display device according to an exemplary embodiment.

FIGS. 2A and 2B show arrangements and electrical connection relationships of testing pixels in a testing area according to exemplary embodiments.

FIG. 3 shows an exemplary embodiment of a detecting circuit in FIG. 1 being used for adjusting the logic low operating voltage Vgl of scan line driving voltage signal.

FIG. 4 shows timing sequences of voltages on various electrical nodes of the detecting circuit in FIG. 3.

FIG. 5 shows a relationship curve of output voltages V3 in FIG. 3 with corresponding logic low testing operating voltages.

FIG. 6 shows another exemplary embodiment of a detecting circuit in FIG. 1 being used for adjusting the logic low operating voltage Vgl of scan line driving voltage signal.

FIG. 7 shows timing sequences of voltages on various electrical nodes of the detecting circuit in FIG. 6.

FIG. 8 shows an exemplary embodiment of a detecting circuit in FIG. 1 being used for adjusting the logic high operating voltage Vgh of scan line driving voltage signal.

FIG. 9 shows timing sequences of voltages on various electrical nodes of the detecting circuit in FIG. 8.

FIG. 10 shows a relationship curve of output voltages V3 in FIG. 8 with corresponding logic high testing operating voltages.

FIG. 11 shows an operating voltage adjusting method applied to the flat panel display device in FIG. 1.

FIG. 12 shows another schematic system architecture view of a flat panel display device according to an exemplary embodiment.

FIG. 13 shows an exemplary embodiment of a detecting circuit in FIG. 12 being used for adjusting the common voltage Vcom.

FIG. 14 shows timing sequences of voltages on various electrical nodes of the detecting circuit in FIG. 13.

FIG. 15 shows a relationship curve of output voltages V3 in FIG. 13 with corresponding testing common voltages.

FIG. 16 shows an operating voltage adjusting method applied to the flat panel display device in FIG. 12.

### DETAILED DESCRIPTION OF EMBODIMENTS

The disclosure will now be described more specifically with reference to the following embodiments. It is to be noted that the following descriptions of embodiments are presented herein for purpose of illustration and description only. It is not intended to be exhaustive or to be limited to the precise form disclosed.

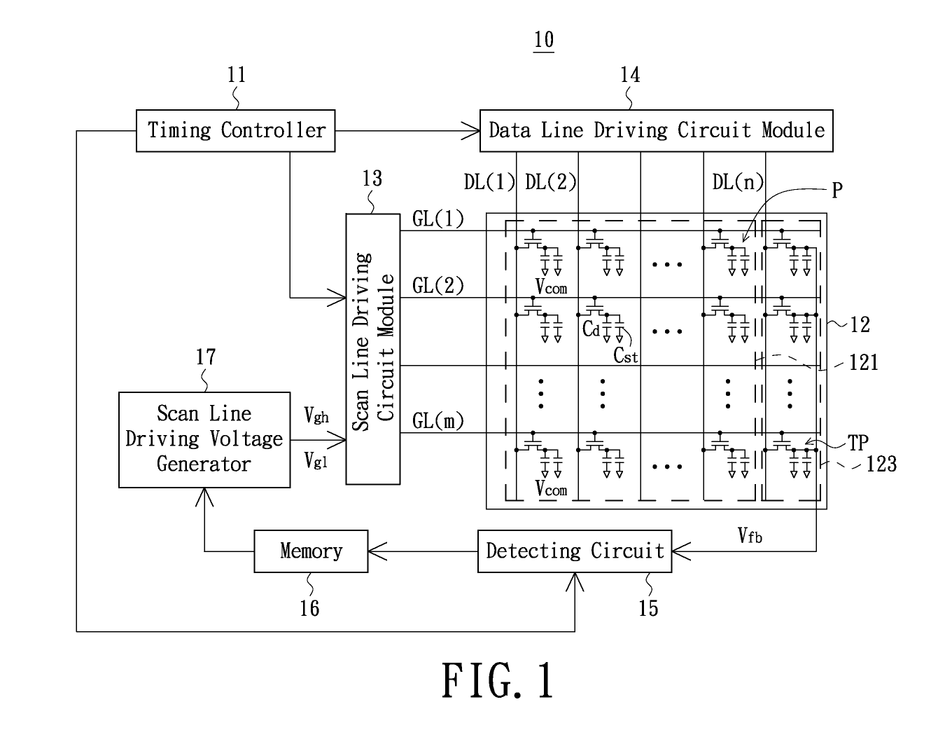

Referring to FIG. 1, a schematic system architecture view of a flat panel display device according to an exemplary embodiment is shown. As shown in FIG. 1, the flat panel display device 10 includes a timing controller 11, an active-type display panel 12, a scan line driving circuit module 13, a data line driving circuit module 14, a detecting circuit 15, a memory 16 and a scan line driving voltage generator 17. The timing controller 11 is configured (i.e., generally structured and arranged) to control timings of the scan line driving circuit module 13, the data line driving circuit module 14 and the detecting circuit 15. The scan line driving circuit module 13 is electrically coupled to scan lines GL(1), GL(2), . . . , GL(m) formed on the active-type display panel 12 to supply scan line driving voltage signals to these scan lines GL(1), GL(2), . . . , GL(m) accordingly. The data line driving circuit module 14 is electrically coupled to data lines DL(1), DL(2), . . . , DL(n) formed on the active-type display panel 12 to supply display data voltage signals to these data lines DL(1), DL(2), . . . , DL(n) accordingly. The scan lines GL(1), GL(2), . . . , GL(m) are arranged crossing with the data lines DL(1), DL(2), . . . , DL(n). In this embodiment, the active-type display panel 12 can be a liquid crystal display panel, but not limited to the present embodiment.

The active-type display panel 12 includes a displaying area 121 and a testing area 123. The displaying area 121 includes a plurality of pixels P. Each of the pixels P is electrically coupled to a corresponding one of the scan lines GL(1), GL(2), . . . , GL(m) and a corresponding one of the data lines DL(1), DL(2), . . . , DL(n) and subjected to the control of a voltage signal provided on the corresponding scan line to determine whether to receive the display data voltage signal from the corresponding data line. Generally, each of the pixels P includes a pixel transistor, a display capacitor Cd (such as a liquid capacitor), and a storage capacitor Cst. A terminal of the storage capacitor Cst and an terminal of the display capacitor Cd both are electrically coupled to the pixel transistor to receive the display data voltage signal, another terminal of the display capacitor Cd is electrically coupled to a first common electrode to receive a common voltage Vcom, and another terminal of the storage capacitor Cst is electrically coupled to a second common electrode to receive the common voltage Vcom. The testing area 123 includes a plurality of testing pixels TP arranged in one column, and each of the testing pixels TP is electrically coupled to the data line DL(n) and a corresponding one of the scan lines GL(1), GL(2), . . . , GL(m). The testing pixels TP may have a same internal structure as the pixels P in the displaying area 121. It is noted that, the testing area 123 may only include single one testing pixel TP instead. In addition, the testing pixels TP may act as pixels P, that is, the testing pixels TP may be used to display image during an image display period.

Referring to FIG. 1 again, the memory 16 stores a plurality of testing operating voltages therein, for examples logic high operating voltages Vgh (i.e., generally the gate-on voltage for the pixel transistor) and/or logic low operating voltages Vgl (i.e., generally the gate-off voltage for the pixel transistor) of different scan line driving voltage signals provided from the scan line driving voltage generator 17. The scan line driving voltage generator 17 is electrically coupled to the memory 16 to obtain the testing operating voltages in sequence during an operating voltage testing period and thereby sequentially supplies power supplies with the respective testing operating voltages to the scan line driving circuit module 13 for use. The detecting circuit 15 is electrically coupled to the memory 16 and the testing pixels TP in the testing area 123, for obtaining data voltages Vfb stored in the testing pixels TP being charged under the effects of the testing operating voltages respectively, selecting one of the testing operating voltages stored in the memory 16 as an operating voltage according to states of the data voltages Vfb and storing the operating voltage in the memory 16. Afterwards, the scan line driving voltage generator 17 can acquire the operating voltage from the memory 16 and supplies a power supply with the operating voltage to the scan line driving circuit module 13 for use during the image display period of the active-type display panel 12.

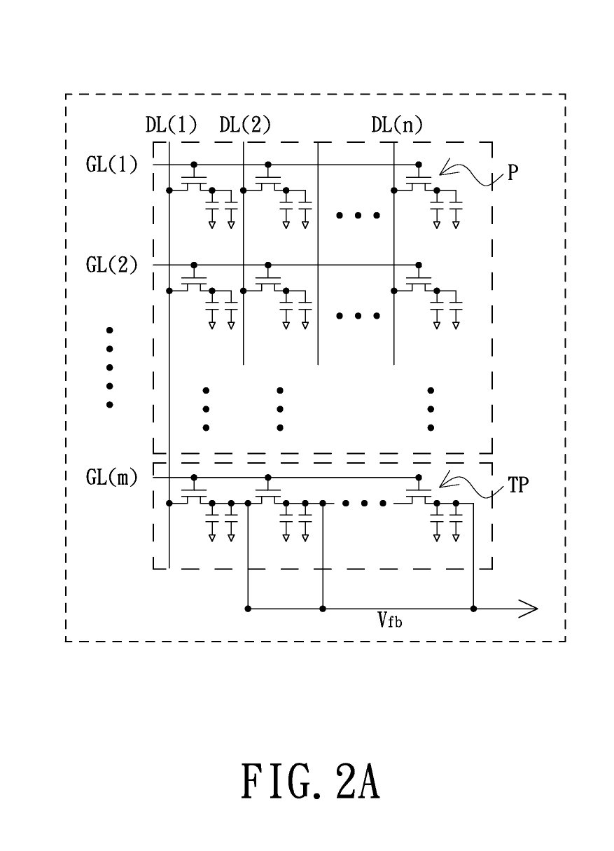

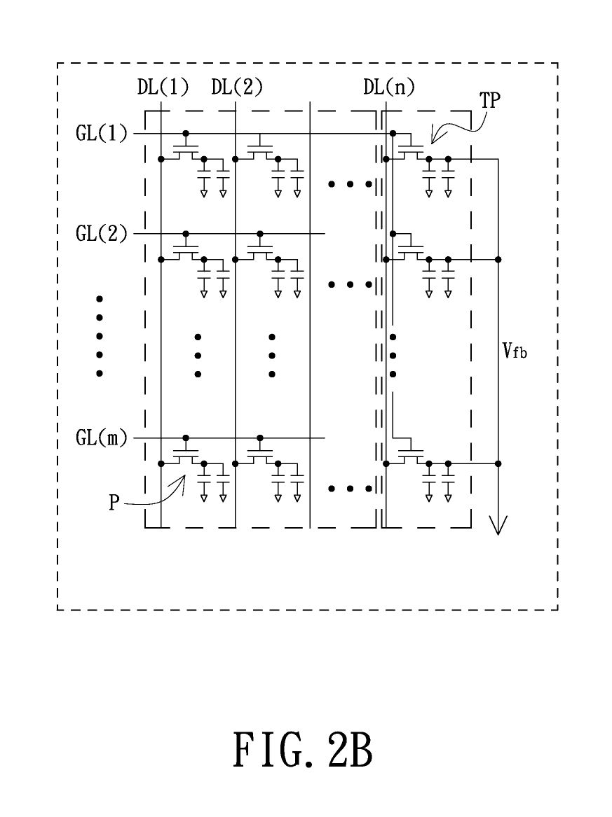

Referring to FIGS. 2A and 2B, in order to avoid affecting charged voltages of the testing pixels TP and the image display quality of the flat panel display device, the testing pixels TP are electrically coupled in parallel and then electrically coupled with the detecting circuit 15 so as to supply the data voltages Vfb to the detecting circuit 15. The testing pixels TP can be a single row of testing pixels electrically coupled in parallel (see FIG. 2A), a single row of testing pixels electrically coupled in parallel (see FIG. 2B), or a matrix of testing pixels electrically coupled in parallel. A purpose of the using of in-parallel electrical connection is to provide a large enough capacitance to avoid charged voltages of the testing pixels TP dramatically to be sunk by the detecting circuit 15 and thereby increase the measuring precision. In particular, as shown in FIG. 2A, the testing pixels TP are arranged in a same row and all electrically coupled to the scan line GL(m) and the data line DL(1) to provide the data voltages Vfb, while each of the pixels P is electrically coupled to a corresponding one of the scan lines GL(1), GL(2), . . . , GL(m-1) (not shown). As shown in FIG. 2B, the testing pixels TP are arranged in a same column and all are electrically coupled with the scan line GL(1) and the data line DL(n) to provide the data voltages Vfb, while each of the pixels P is electrically coupled to a corresponding one of the data lines DL(1), DL(2), . . . , DL(n-1) (not shown).

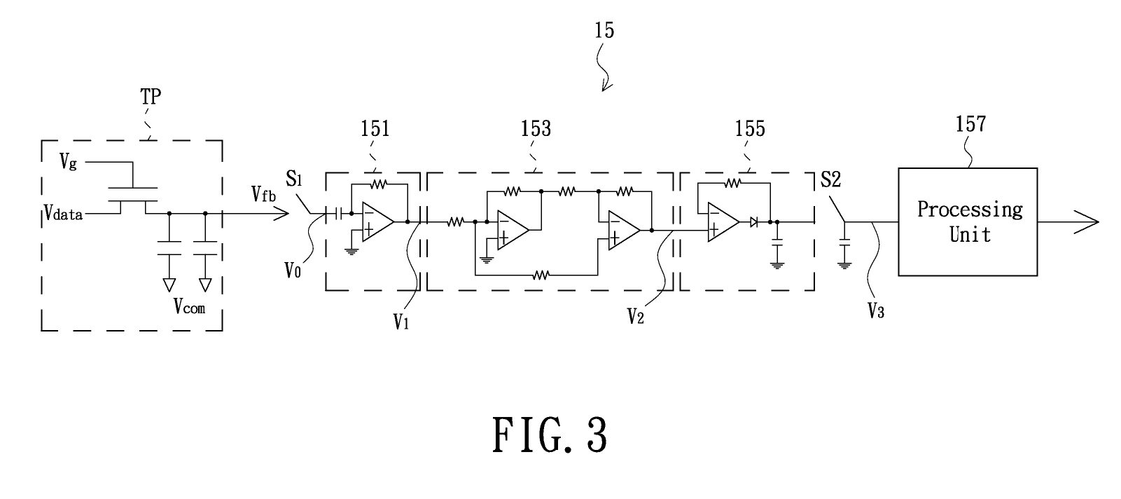

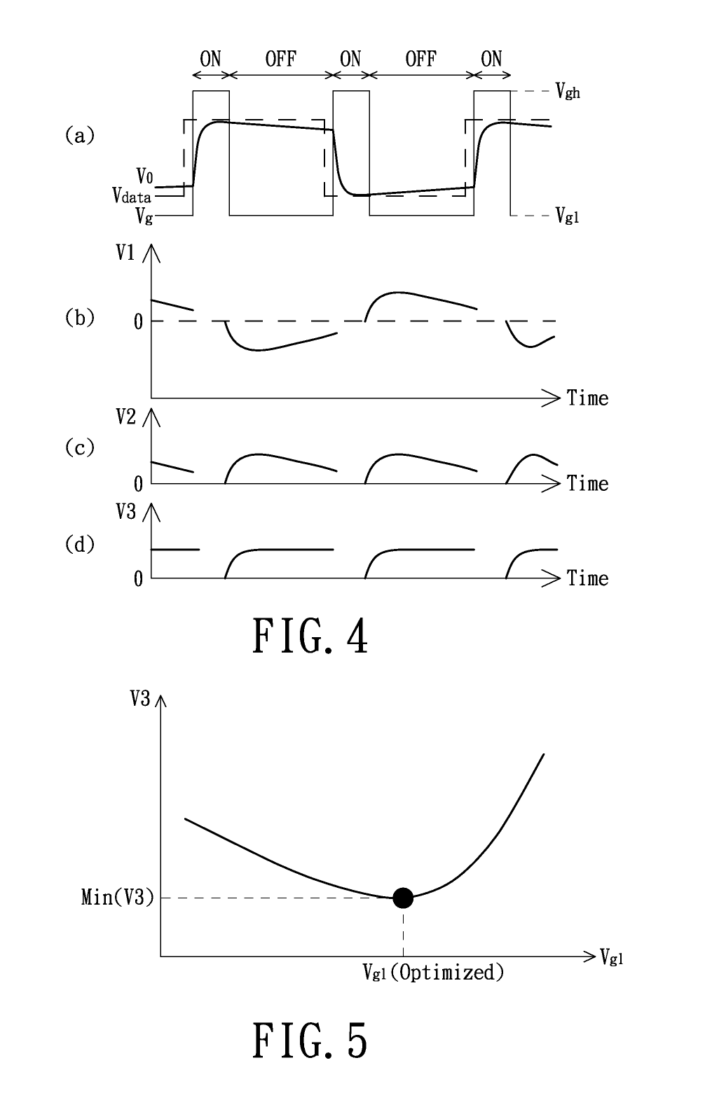

Referring to FIGS. 3 and 4, FIG. 3 shows an exemplary embodiment of the detecting circuit 15 being used for adjusting a logic low operating voltage Vgl of scan line driving voltage signal, and FIG. 4 shows timing sequences of voltages on various electrical nodes in the detecting circuit 15 of FIG. 3. More specifically, as shown in FIG. 3, the alphabetic reference TP represents a single testing pixel or a group of testing pixels connected in parallel. In the present embodiment, the single testing pixel TP is described as an example. When the gate of the pixel transistor (as a switching unit) in the testing pixel TP is turned on by a scan line driving voltage signal Vg applied thereto and the source/drain of the pixel transistor has a display data voltage signal Vdata provided thereto, the drain/source of the pixel transistor outputs a data voltage Vfb. When a switching unit S1 of the detecting circuit 15 electrically coupled to the testing pixel TP is turned on, the data voltage Vfb is outputted as an input voltage V0 of the detecting circuit 15. During the scan line driving voltage signal Vg is at ON-state, the data voltage Vfb is charged to approach the display data voltage signal Vdata, while during the scan line driving voltage signal Vg is at OFF-state, the data voltage Vfb is changed caused by current leakage.

A first stage of the detecting circuit 15 includes the switching unit S1 and a differentiator 151. The differentiator 151 includes two input terminals, one of the two input terminals is electrically coupled to the testing pixel TP via the switching unit S1, and the other one of the two input terminals is electrically coupled to a predetermined voltage e.g., a grounding voltage. During the scan line driving voltage signal Vg is at the ON-state, the switching unit S1 is turned off so that the detecting circuit 15 is open-circuit, while during the scan line driving voltage signal Vg is at the OFF-state, the switching unit S1 is turned on so that the testing pixel TP is electrically communicated with the input terminal of the detecting circuit 15. After a voltage difference between the input voltage V0 and the grounding voltage (as shown in FIG. 4(a)) is processed by the differentiator 151, an output terminal of the differentiator 151 generates an output voltage V1=dV0/dt, i.e., a sloping operation is applied to the input voltage V0 (shown in FIG. 4(b)) and such slope is varied with time.

A second stage of the detecting circuit 15 includes a rectifier 153 such as a full-wave rectifier. An input terminal of the rectifier 153 is electrically coupled to the output terminal of the differentiator 151. After the output voltage V1 is rectified by the rectifier 153, an output terminal of the rectifier 153 generates an output voltage V2=|V1|. In order words, the output voltage V1 from the differentiator 151 is performed with an absolute operation (shown in FIG. 4(c)).

A third stage of the detecting circuit 15 includes a peak detector 155. An input terminal of the peak detector 155 is electrically coupled to the output terminal of the rectifier 153 to receive the output voltage V2. The peak detector 153 processes the received output voltage V2 and then generates an output voltage V3=Max(V2) on an output terminal of the peak detector 153. In order words, the output voltage V2 from the rectifier 153 is performed with a maximum operation (shown in FIG. 4(d)).

A fourth stage of the detecting circuit 15 includes a switching unit S2 and a processing unit 157. The switching unit S2 is synchronously turned on with the switching unit S1 in the first stage of the detecting circuit 15. The processing unit 157 is electrically coupled to the peak detector 155 via the switching unit S2 to receive the output voltage V3 from the peak detector 155. In this embodiment, multiple output voltages V3 can be obtained by supplying the testing operating voltages Vgl in sequence, for example the testing operating voltages Vgl are switched along the switching of image frame. Afterwards, the processing unit 157 determines one of the testing operating voltage (i.e., the optimal testing operating voltage Vgl) corresponding to the minimum one of the output voltages V3, i.e., Min(V3) (as shown in FIG. 5, a relationship curve of the output voltages V3 with the corresponding testing operating voltages is illustrated) as an operating voltage during the image display period. As a result, the purpose of adjusting the logic low operating voltage (i.e., generally gate-off voltage) Vgl of scan line driving voltage signal is achieved.

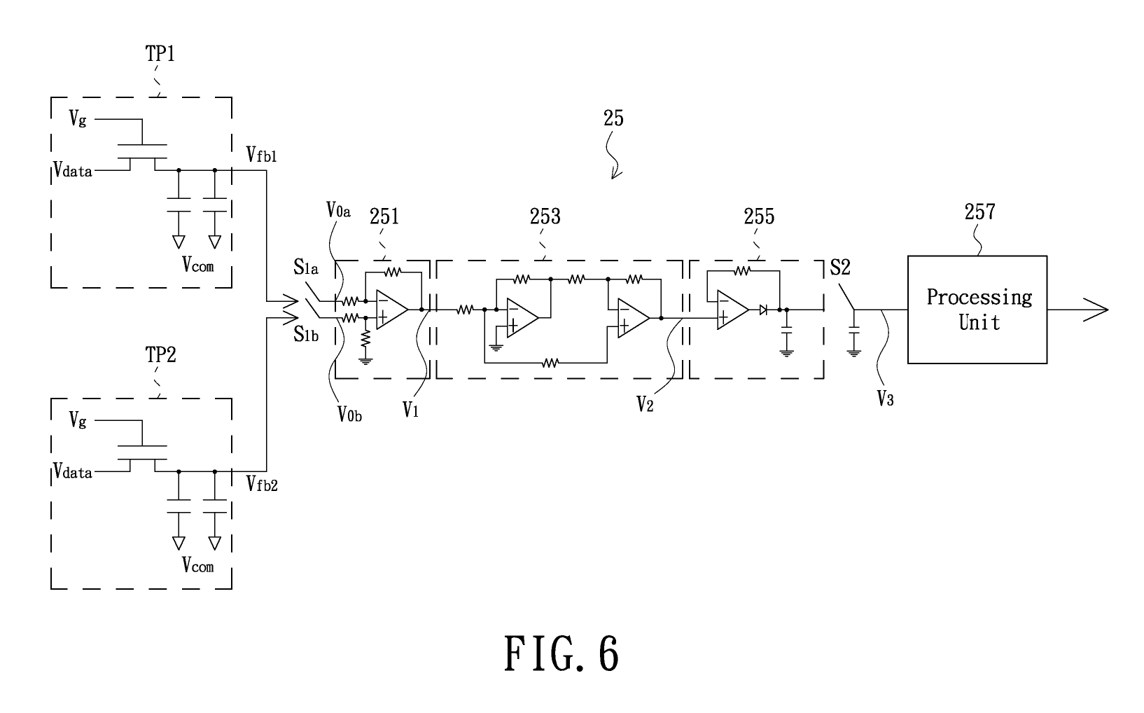

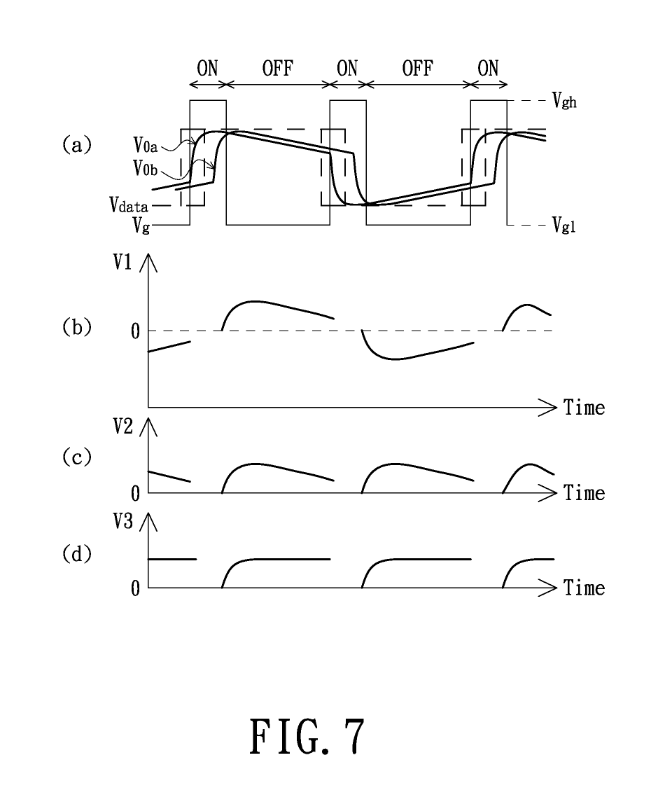

Referring to FIGS. 6 and 7, FIG. 6 shows another exemplary embodiment of the detecting circuit 25 being used for adjusting the logic low operating voltage Vgl of scan line driving voltage signal, and FIG. 7 shows timing sequences of voltages on various electrical nodes of the detecting circuit 25 of FIG. 6. More specifically, as shown in FIG. 6, TP1 and TP2 respectively represent two testing pixels electrically coupled to different scan lines, or two groups of in-parallel connected testing pixels electrically coupled to different scan lines. In the present embodiment, two testing pixels TP1, TP2 electrically coupled to different scan lines are described as an example. When the gates of the pixel transistors (as switching units) of the respective testing pixels TP1 and TP2 are turned on by a same scan line driving voltage signal Vg applied thereto and the sources/drains of the respective pixel transistors are provided with a same display data voltage signal Vdata, the drains/sources of the respective pixel transistors output the data voltages Vfb1 and Vfb2 respectively. When switching units S1a and S1b of the detecting circuit 25 respectively electrically coupled to the testing pixels TP1 and TP2 are turned on, the data voltages Vfb1 and Vfb2 are respectively used as two input voltages V0a and V0b of the detecting circuit 25. During the scan line driving voltage signal Vg is at ON-state, the data voltages Vfb1 and Vfb2 both are charged to approach the display data voltage signal Vdata, while during the scan line driving voltage signal Vg is at OFF-state, the data voltages Vfb1 and Vfb2 are changed caused by current leakage.

A first stage of the detecting circuit 25 includes the switching units S1a and S1b, and a subtractor 251. The subtractor 251 includes two input terminals respectively electrically coupled to the testing pixels TP1 and TP2 via the respective switching units S1a and S1b. During the scan line driving voltage signal Vg is at the ON-state, the switching units S1a and S1b are turned off so that the detecting circuit 25 is open-circuit. During the scan line driving voltage signal Vg is at the OFF-state, the switching units S1a and S1b are turned on so that the testing pixels TP1 and TP2 are respectively electrically communicated with the two input terminals of the detecting circuit 25. The input voltages V0a and V0b (shown in FIG. 7(a)) then are processed by the subtractor 251, and an output terminal of the subtractor 251 consequently generates an output voltage V1=(V0b−V0a). That is, the output voltage V1 is the voltage difference between the input voltages V0a, V0b obtained by performing a subtraction operation (see FIG. 7(b)).

A second stage of the detecting circuit 25 includes a rectifier 253 such as a full-wave rectifier. An input terminal of the rectifier 253 is electrically coupled to the output terminal of the subtractor 251 to receive the output voltage V1. The rectifier 253 performs a rectifying operation to the output voltage V1, and then generates an output voltage V2=|V1| on an output terminal of the rectifier 253. In order words, the output voltage V1 from the subtractor 251 is performed with an absolute operation (see FIG. 7(c)).

A third stage of the detecting circuit 25 includes a peak detector 255. An input terminal of the peak detector 255 is electrically coupled to the output terminal of the rectifier 253. The output voltage V2 outputted from the rectifier 253 is processed by the peak detector 255, and then an output terminal of the peak detector 255 generates an output voltage V3=Max(V2). In order words, the output voltage V2 from the rectifier 253 is performed with a maximum operation (see FIG. 7(d)).

A fourth stage of the detecting circuit 25 includes a switching unit S2 and a processing unit 257. The switching unit S2 is synchronously turned on with the switching units S1 and S1b of the first stage of the detecting circuit 25. The processing unit 257 is electrically coupled to the output terminal of the peak detector 255 via the switching unit S2 to receive the output voltage V3 of the peak detector 255. In the present embodiment, multiple output voltages V3 can be obtained by providing the testing operating voltages Vgl in sequence, for example the testing operating voltage Vgl are switched along the switching of image frame. Afterwards, the processing unit 257 determines one of the testing operating voltages (i.e., the optimal testing operating voltage Vgl) corresponding to the minimum one of the output voltages V3 (i.e., Min(V3)) (see FIG. 5, a relationship curve of the output voltages V3 with the corresponding testing operating voltages is shown) as an operating voltage during the image display period. As a result, the purpose of adjusting the logic low operating voltage Vgl of scan line driving voltage signal is achieved.

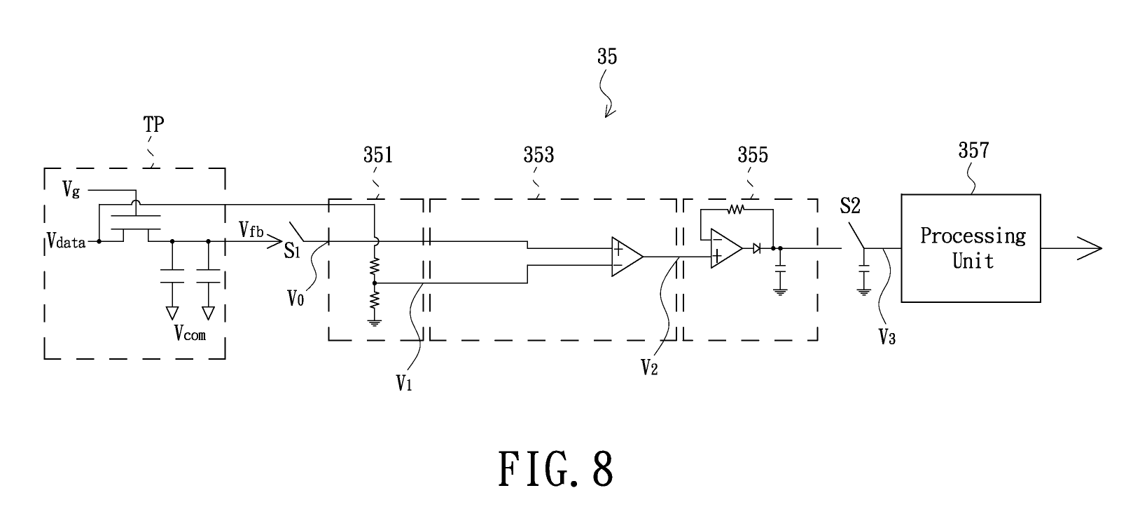

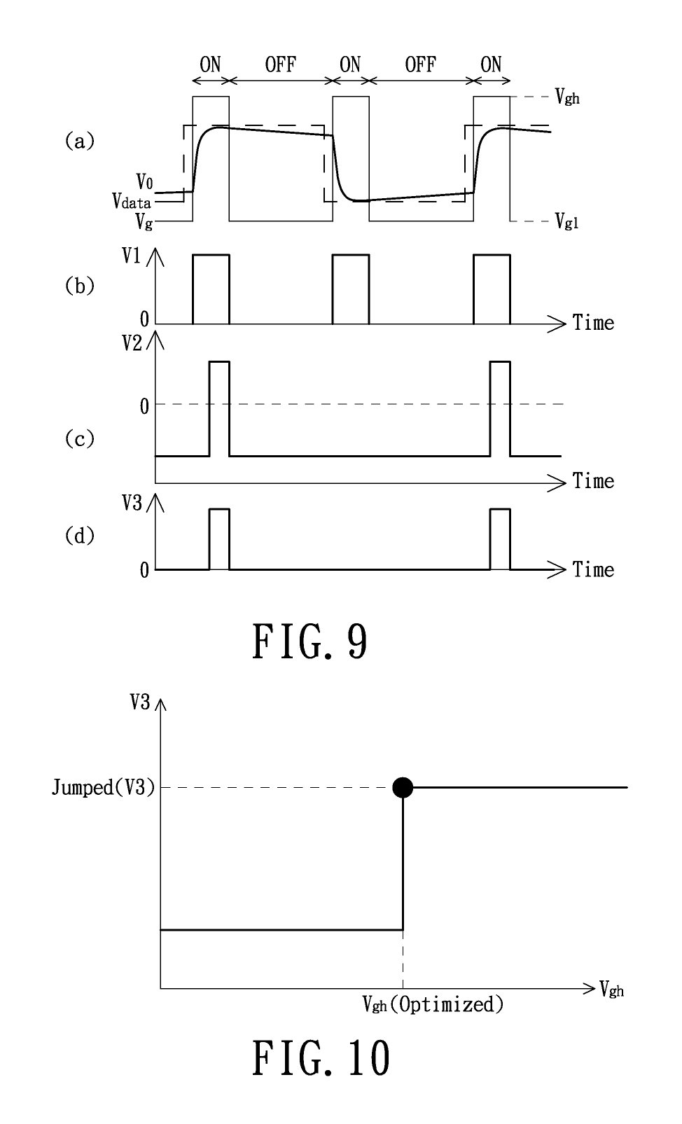

Referring to FIGS. 8 and 9, FIG. 8 shows an exemplary embodiment of the detecting circuit being used for adjusting a logic high operating voltage Vgh of scan line driving voltage signal, and FIG. 9 shows timing sequences of voltages on various electrical nodes of the detecting circuit 35 of FIG. 8. More specifically, as shown in FIG. 8, TP represents a single testing pixel or a group of in-parallel connected testing pixels. In the present embodiment, a single testing pixel TP is described as an example. When the gate of the pixel transistor (as a switching unit) of the testing pixel TP is turned on by a scan line driving voltage signal Vg applied thereto and the source/drain of the pixel transistor is provided with a display data voltage signal Vdata, the drain/source of the pixel transistor outputs the data voltage Vfb. When a switching unit S1 of the detecting circuit 35 electrically coupled to the testing pixel TP is turned on, the data voltage Vfb acts as an input voltage V0 of the detecting circuit 35. During the scan line driving voltage signal Vg is at ON-state, the data voltage Vfb is charged to approach the display data voltage signal Vdata, while during the scan line driving voltage signal Vg is at OFF-state, the data voltage Vfb is changed caused by current leakage.

A first stage of the detecting circuit 35 includes the switch member Si and a voltage divider 351. The voltage divider 351 is electrically coupled to the data line which is electrically coupled with the testing pixel TP so as to receive the display data voltage signal Vdata and performs a voltage dividing operation to the received display data voltage signal Vdata. During the scan line driving voltage signal Vg is at the OFF-state, the switching unit S1 is turned off so that the detecting circuit 35 is open-circuit. While during the scan line driving voltage signal Vg is at the ON-state, the switching unit S1 is turned on so that the testing pixel TP is electrically communicated with the input terminal of the detecting circuit 35 to provide the input voltage V0 (see FIG. 9(a)). The display data voltage signal Vdata received by the detecting circuit 35 is divided by the voltage divider 351, and then an output terminal of the voltage divider 351 generates an output voltage V1=K×Vdata (see FIG. 9(b)). The output voltage V1 serves as a comparing reference voltage for determining whether the testing pixel TP is fully charged or not.

A second stage of the detecting circuit 35 includes a comparator 353. The comparator 353 compares the input voltage V0 with V1. If V0>V1, an output terminal the comparator 353 generates an output voltage V2=+V(sat), while if V0<V1, the output terminal of the comparator 353 generates the output voltage V2=−V(sat) (see FIG. 9(c)). Herein, +V(sat) represents a positive saturation voltage, and -V(sat) represents a negative saturation voltage.

A third stage of the detecting circuit 35 includes a peak detector 355. An input terminal of the peak detector 355 is electrically coupled to the output terminal of the comparator 353 to receive the output voltage V2. The peak detector 355 processes the output voltage V2 and then generates an output voltage V3=Max(V2) on an output terminal of the peak detector 355. In order words, the output voltage V2 from the comparator 353 is performed with a maximum operation (see FIG. 9(d)).

A fourth stage of the detecting circuit 35 includes a switching unit S2 and a processing unit 357. The switching unit S2 is synchronously turned on with the switching unit S1 in the first stage of the detecting circuit 35. The processing unit 357 is electrically coupled to the output terminal of the peak detector 355 via the switching unit S2 so as to receive the output voltage V3. In the present embodiment, multiple output voltages V3 can be obtained by providing the testing operating voltages Vgl in sequence, for example the testing operating voltages Vgl are switched along the switching of image frame. Afterwards, the processing unit 357 determines one of the testing operating voltages corresponding to a jumped one of the output voltages V3 (i.e., the optimal testing operating voltage Vgh, see FIG. 10, a relationship curve of the output voltages V3 with the corresponding testing operating voltages) respectively corresponding to the testing operating voltages in an ascending order as an operating voltage during the image display period. As a result, the purpose of adjusting the operating voltage Vgh of scan line driving voltage signal is achieved.

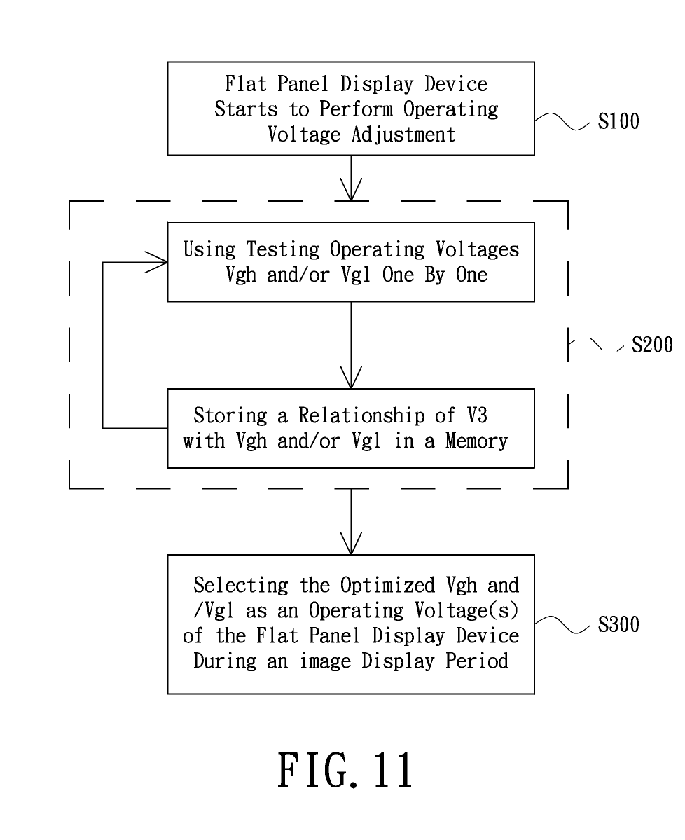

In short, an operating voltage adjusting process used in the flat panel display device 10 of FIG. 1 can refer to FIG. 11. In particular, after flat panel display device 10 starts to perform an operating voltage adjustment (step S100), a plurality of testing operating voltages Vgh and/or Vgl are provided from the memory 16 in sequence and a relationship of the output voltages V3 of the detecting circuit 15, 25 or 35 with the corresponding testing operating voltages Vgh and/or Vgl is stored in the memory 16 (step S200). Afterwards, the scan line driving voltage generator 17 acquires the optimal testing operating voltage(s) Vgh and/or Vgl as an operating voltage(s) of the flat panel display device 10 for use during the image display period (step S300).

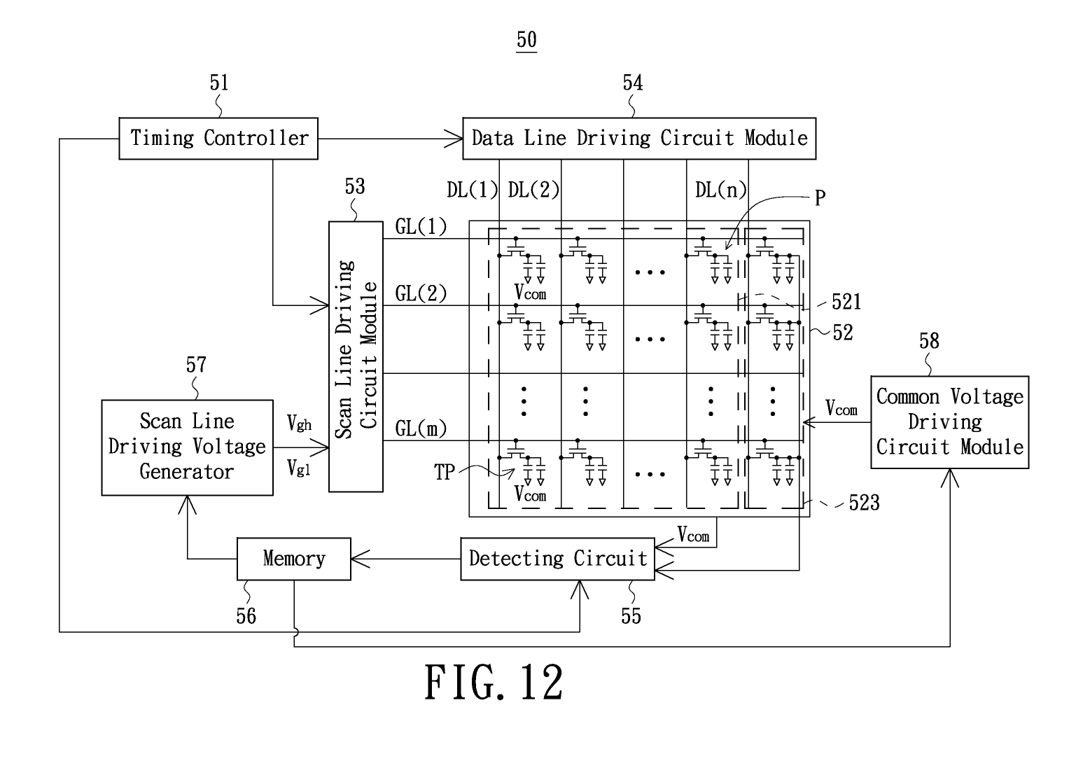

Referring to FIG. 12, a schematic system architecture view of a flat panel display device according to another exemplary embodiment is shown. As shown in FIG. 12, the flat panel display device 50 includes a timing controller 51, an active-type display panel 52, a scan line driving circuit module 53, a data line driving circuit module 54, a detecting circuit 55, a memory 56, a scan line driving voltage generator 57 and a common voltage driving circuit module 58. The timing controller 51 is configured to control timings of the scan line driving circuit module 53, the data line driving circuit module 54 and the detecting circuit 55. The scan line driving circuit module 53 is electrically coupled to scan lines GL(1), GL(2), . . . , GL(m) formed on the active-type display panel 52 to supply scan line driving voltage signals to these scan lines GL(1), GL(2), . . . , GL(m). The data line driving circuit module 54 is electrically coupled to data lines DL(1), DL(2), . . . , DL(n) formed on the active-type display panel 52 to supply display data voltage signals to these data lines DL(1), DL(2), . . . , DL(n). The scan lines GL(1), GL(2), . . . , GL(m) are arranged crossing with the data lines DL(1), DL(2), . . . , DL(n). In the present embodiment, the active-type display panel 52 can be a liquid crystal display device, but not limited to this example.

The active-type display panel 52 includes a displaying area 521 and a testing area 523. The displaying area 521 includes a plurality of pixels P. Each of the pixels P is electrically coupled to a corresponding one of the scan lines GL(1), GL(2), . . . , GL(m) and a corresponding one of the data lines DL(1), DL(2), . . . , DL(n) and subjected to the control of a voltage signal provided on the corresponding scan line to determine whether to receive display data voltage signal from the corresponding data line. Each of the pixels P usually includes a pixel transistor, a display capacitor Cd (such as a liquid capacitor) and a storage capacitor Cst. A terminal of the storage capacitor Cst and a terminal of the display capacitor Cd both are electrically coupled to the pixel transistor to receive the display data voltage signal, another terminal of the display capacitor Cd is electrically coupled to a first common electrode to receive a common voltage Vcom, and another terminal of the storage capacitor Cst is electrically coupled to a second common electrode to receive the common voltage Vcom. The testing area 523 includes a plurality of testing pixels TP arranged in one column. The testing pixels TP are respectively electrically coupled to the scan lines GL(1), GL(2), . . . , GL(m) and all are electrically coupled to the data line DL(n). The testing pixels TP may have the same internal structure as the pixels P in the displaying area 521. It is noted that, the testing area 523 may only include a single testing pixel TP, or a group of testing pixel TP arranged in one column or in one row and electrically coupled to different scan lines or a same scan line. In addition, the testing pixels TP may serve as pixels P, that is to say, the testing pixels TP also can be used for image display during an image display period. Furthermore, the common voltage driving circuit module 58 is electrically coupled to the active-type display panel 52 and generally includes a power supply circuit to supply the common voltage Vcom to the displaying area 521 during the image display period and supply multiple testing common voltages Vcom in sequence to the testing area 523 during a common voltage testing period.

Referring to FIG. 12 again, the memory 56 stores multiple testing operating voltages therein, for examples logic high operating voltages Vgh of different scan lines driving voltage signals, logic low operating voltages Vgl of different scan lines driving voltage signals and/or testing common voltages Vcom. The scan line driving voltage generator 57 is electrically coupled to the memory 56 and serves as a power supply circuit to obtain the testing operating voltages Vgh and/or Vgl and thereby sequentially provide power supplies with the respective testing operating voltages to the scan line driving circuit module 53 for use during a logic high operating voltage and/or logic low operating voltage testing period. The common voltage driving circuit module 58 also is electrically coupled to the memory 56 to obtain the testing common voltages Vcom and thereby sequentially provide power supplies with the respective testing common voltages Vcom to itself for use during a common voltage testing period. The detecting circuit 55 is electrically coupled to the memory 56 and the testing pixels TP of the testing area 523 to obtain data voltages Vfb stored in the testing pixels TP being charged effected/influenced by the respective testing operating voltages and to optionally obtain the testing common voltages Vcom.

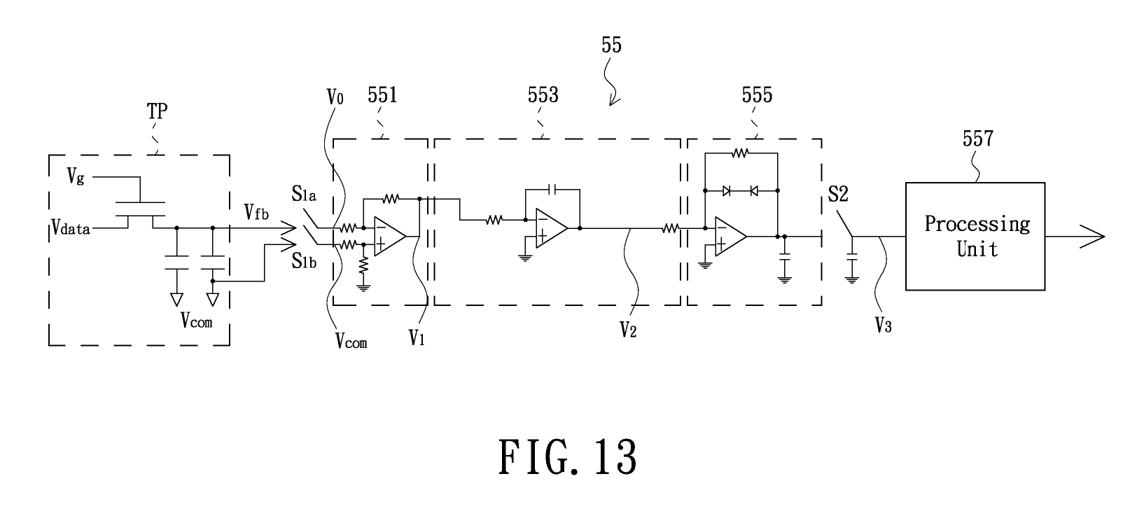

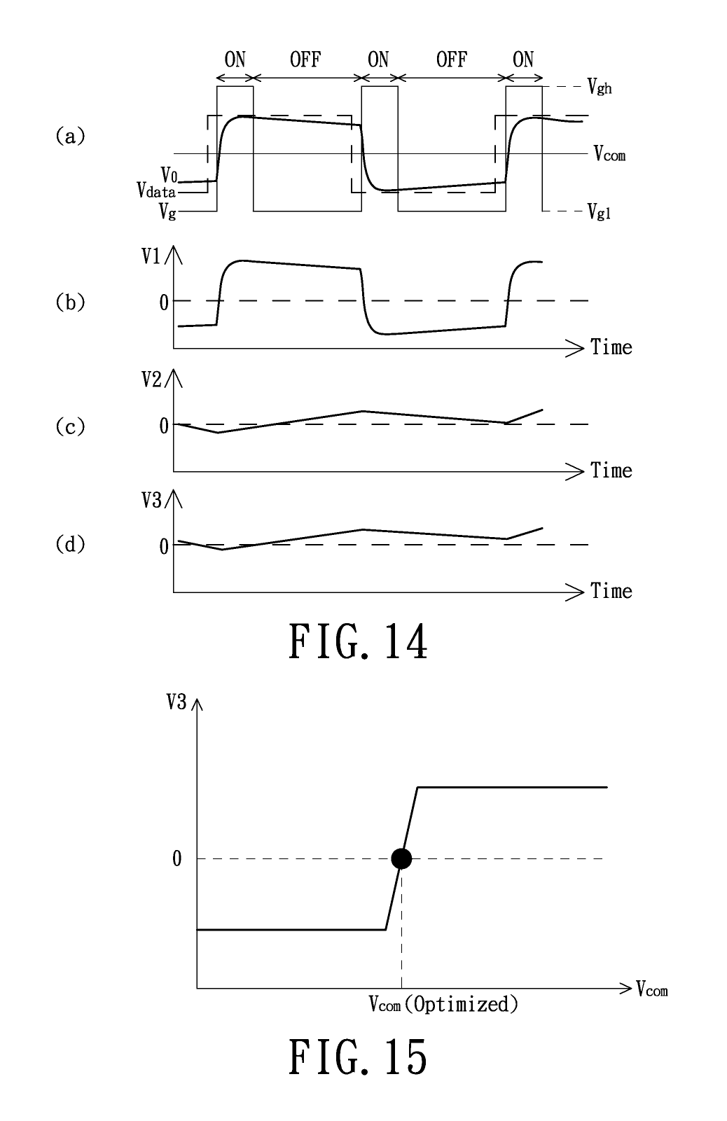

Referring to FIGS. 13 and 14, FIG. 13 shows an exemplary embodiment of the detecting circuit 55 being used for adjusting a common voltage Vcom, and FIG. 14 shows timing sequences of voltages on various electrical connections of the detecting circuit 55 of FIG. 13. More specifically, as shown in FIG. 13, TP represents a single testing pixel or a group of in-parallel connected testing pixels. In the present embodiment, a single testing pixel TP is described as an example. When the gate of the pixel transistor (switching unit) of the testing pixel TP is turned on by a scan line driving voltage signal Vg applied thereto and the drain/source of the pixel transistor is provided with a display data voltage signal Vdata, the drain/source of the pixel transistor outputs the data voltage Vfb, and the terminal of the storage capacitor of the testing pixel TP electrically coupled to the second common electrode outputs the testing common voltage Vcom. When switching units S1a and S1b of the detecting circuit 55 electrically coupled to the testing pixel TP are turned on, the data voltage Vfb is outputted via the switching unit S1a as an input voltage V0 of the detecting circuit 55, and the testing common voltage Vcom is outputted via the switch member S1b to the detecting circuit 55. During the scan line driving voltage signal Vg is at ON-state, the data voltage Vfb is charged to approach the display data voltage signal Vdata, while during the scan line driving voltage signal Vg is at OFF-state, the data voltage Vfb is changed caused by current leakage.

A first stage of the detecting circuit 55 includes the switching units S1a and S1b, and a subtractor 551. The subtractor 551 includes two input terminals respectively electrically coupled to two terminals of the display capacitor in the testing pixel TP (i.e., the pixel electrode and the second or first common electrode) via the switching units S1a and S1b so as to receive the data voltage Vfb and the testing common voltage Vcom. The subtractor 551 processes the input voltages V0 and Vcom (shown in FIG. 14(a)), and then an output terminal of the subtractor 551 generates an output voltage V1=(V0−Vcom) (i.e., being equal to a voltage difference across the display capacitor). In other words, the output voltage V1 from the subtractor 551 is the voltage difference between the data voltage Vfb and the corresponding testing common voltage Vcom obtained by performing a subtraction operation (see FIG. 14(b)).

A second stage of the detecting circuit 55 includes an integrator 553. An input terminal of the integrator 553 is electrically coupled to the output terminal of the subtractor 551 to receive the output voltage V1 for integrating with time. If positive and negative half-periods of the output voltage V1 are asymmetric, an output terminal of the integrator 553 generates an output voltage V2 (i.e., a result of integrating) increasing or decreasing with time (see FIG. 14(c)). Therefore, the detecting circuit 55 is able to detect whether the positive and negative half-periods of the output voltage V1 are symmetric or not.

A third stage of the detecting circuit 55 includes a voltage limiter 555. The voltage limiter 555 has an input terminal electrically coupled to the output terminal of the integrator 553 to receive the output voltage V2. The voltage limiter 555 performs maximum and minimum value limits to the output voltage V2, and then an output terminal of the voltage limiter 555 generates an output voltage V3 (see FIG. 14(d)). It is noted that, the voltage limiter 555 whether or not configured in the detecting circuit 55 is determined according to actual application requirements.

A fourth stage of the detecting circuit 55 includes a switching unit S2 and a processing unit 557. The switching unit S2 is synchronously turned on with the switching units S1a and S1b of the first stage of the detecting circuit 55. The processing unit 557 is electrically coupled to the voltage limiter 555 via the switching unit S2 to receive the output voltage V3 from the voltage limiter 555. After the processing unit 557 receiving multiple output voltages V3 respectively corresponding to the testing common voltages Vcom, the processing unit 557 sets the bigger one or the smaller one from two of the testing common voltages Vcom being with neighboring values and resulting in different integrating results as a common voltage for use during the image display period.

In the present embodiment, multiple output voltages V3 can be obtained by providing different testing common voltages Vcom in sequence, for example the testing common voltages Vcom are switched along the switching of image frame. As shown in FIG. 15, when the testing common voltage Vcom is relatively small, the output voltage V1 in the positive half-period is larger than that in the negative half-period, and after being processed by the integrator 553 and the voltage limiter 555, the output voltage V3 is corresponding to a negative saturation voltage (−V(sat)). Whereas, when the testing common voltage Vcom is relatively large, the output voltage V1 of the positive half-period is smaller than that of the negative half-period, and after being processed by the integrator 553 and the voltage limiter 555, the output voltage V3 is corresponding to a positive saturation voltage (+V(sat)). Accordingly, When the output voltage V3 is jumped, the testing common voltage Vcom corresponding to the jumped output voltage V3 is the optimal testing common voltage, e.g., the testing common voltage Vcom corresponding to the zero voltage as shown in FIG. 15. The optimal testing common voltage Vcom can be acquired by the common voltage driving circuit module 58 from the memory 56 as the common voltage for use during an image display period of the flat panel display device 50. As a result, the purpose of adjusting the common voltage Vcom is achieved.

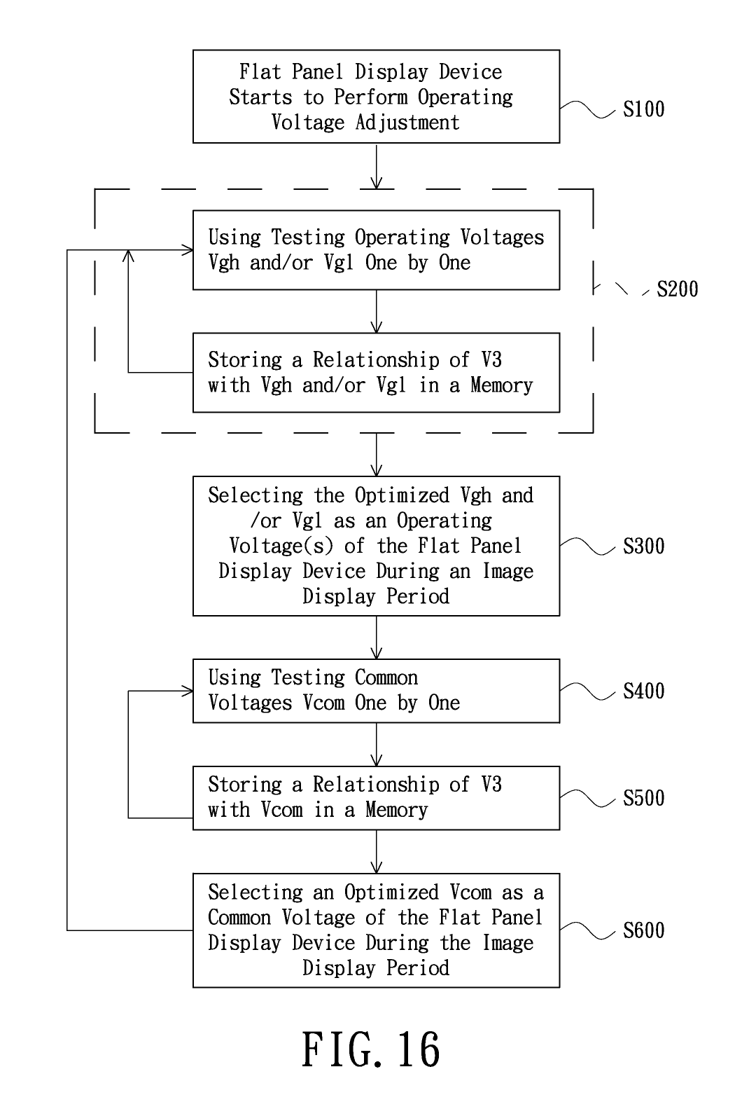

In short, the operating voltage adjusting process applied to the flat panel display device 50 of FIG. 12 can refer to FIG. 16. In particular, after the flat panel display device 50 performing the steps S100-S300 to obtain the optimal Vgh and/or Vgl, different testing common voltage Vcom are acquired from the memory 56 in sequence (step S400) and a relationship of the output voltages V3 of the detecting circuit 55 with the testing common voltages Vcom is stored in the memory 56 (step S500). Afterwards, the common voltage driving circuit module 58 acquires the optimal testing common voltage Vcom from the memory 56 for use during the image display period (step S600), so as to suppress the image flicker. It is indicated that, the steps S100-S600 can be repeatedly carried out to find out the optimal Vgh and/or Vgl, and/or Vcom.

Sum up, the above various embodiments are adapted to perform an automatic operating voltage adjustment for the flat panel display device to improve the display quality, and primarily use the detecting circuit to detect the variation of electrical property for pixel and then inform the scan line driving circuit module and/or the common voltage driving circuit module to supply an appropriate operating voltage for use based on the detect result. As a result, the flat panel display device can reduce the influence of display quality resulting from different operating conditions such as temperature, humidity and/or product life cycle, achieving an improved display quality.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An operating voltage adjusting method for a flat panel display device comprising at least a first testing pixel, the operating voltage adjusting method comprising:
providing a plurality of testing operating voltages;
enabling the at least a first testing pixel operative with the testing operating voltages in sequence to be charged by a first specific data;
obtaining a plurality of first data voltages stored in the at least a first testing pixel effected by the testing operating voltages respectively; and
determining an operating voltage of the flat panel display device according to states of the first data voltages in a specific period.

2. The operating voltage adjusting method according to claim 1, wherein the operating voltage is a logic low voltage on scan lines of the flat panel display device.

3. The operating voltage adjusting method according to claim 2, wherein the step of determining an operating voltage of the flat panel display device according to states of the first data voltages in a specific period comprises:
obtaining a slope of a voltage difference between each of the first data voltages and a predetermined voltage varied with time to thereby obtain a plurality of slopes respectively corresponding to the first data voltages;
generating a plurality of maximum absolute values of the respective slopes; and
setting one of the testing operating voltages corresponding to a minimum one of the maximum absolute values as the operating voltage.

4. The operating voltage adjusting method according to claim 2, wherein the step of determining an operating voltage of the flat panel display device according to states of the first data voltages in a specific period comprises:
obtaining a data difference between each of the first data voltages and a corresponding one of a plurality of second data voltages to thereby obtain a plurality of data differences, wherein the second data voltages are stored results in at least a second testing pixel respectively effected by the same testing operating voltages used by the at least a first testing pixel after the at least a second testing pixel operative with the same testing operating voltages in sequence being enabled by a scan line driving voltage signal to be charged by the first specific data, the scan line driving voltage signal is with a timing sequence different from that for enabling the at least a first testing pixel;
generating a plurality of maximum absolute values of the respective data differences; and
setting one of the testing operating voltages corresponding to a minimum one of the maximum absolute values as the operating voltage.

5. The operating voltage adjusting method according to claim 1, wherein the operating voltage is a logic high voltage on scan lines of the flat panel display device.

6. The operating voltage adjusting method according to claim 5, wherein the step of determining an operating voltage of the flat panel display device according to states of the first data voltages in a specific period comprises:
generating a comparing result by comparing each of the first data voltages with a predetermined voltage to thereby obtain a plurality of comparing results respectively corresponding to the first data voltages; and
setting one of the testing operating voltages corresponding to a jumped one of the comparing results respectively corresponding to the testing operating voltages in an ascending order as the operating voltage.

7. The operating voltage adjusting method according to claim 1, further comprising:
providing a plurality of testing common voltages;
enabling the at least a first testing pixel cooperative with the testing common voltages in sequence to be charged by a second specific data;
obtaining a plurality of second data voltages stored in the at least a first testing pixel effected by the testing common voltages respectively;
generating an integrating result of a difference between each of the second data voltages and the corresponding one of the testing common voltages to thereby obtain a plurality of integrating results; and
selecting one of the testing common voltages corresponding to one of the integrating results substantially approaching a predetermined voltage as a common voltage of the flat panel display device.

8. A flat panel display device comprising:
a plurality of data lines, for providing display data voltage signals;
a plurality of scan lines;
a displaying area, comprising a plurality of pixels, each of the pixels being electrically coupled to a corresponding one of the scan lines and a corresponding one of the data lines and thereby subjected to the control of a signal provided on the corresponding scan line to determine whether to receive the display data voltage signal from the corresponding data line;
a testing area, comprising a first testing pixel electrically coupled to a corresponding one of the scan lines and a corresponding one of the data lines;
a memory, for storing a plurality of testing operating voltages;
a detecting circuit, electrically coupled to the memory and the first testing pixel, for obtaining first data voltages stored in the first testing pixel being charged under effects of the testing operating voltages respectively, selecting one of the testing operating voltages stored in the memory as an operating voltage of the flat panel display device according to states of the first data voltages and storing the operating voltage in the memory; and
a power supply circuit, electrically coupled to the memory to acquire the operating voltage, for supplying a power supply with the operating voltage to an electronic device in the flat panel display device for use during a first period and sequentially supplying power supplies with the respective testing operating voltages to the electronic device in the flat panel display device for use during a second period.

9. The flat panel display device according to claim 8, wherein the detecting circuit comprises:
a differentiator, comprising two input terminals, wherein one of the two input terminals is electrically coupled to the first testing pixel to receive the first data voltages, and the other one of the two input terminals is electrically coupled to a predetermined voltage;
a rectifier, wherein an input terminal of the rectifier is electrically coupled to an output terminal of the differentiator;
a peak detector, wherein an input terminal of the peak detector is electrically coupled to an output terminal of the rectifier, and an output terminal of the peak detector is for outputting maximum absolute values respectively corresponding to the first data voltages; and
a processing unit, electrically coupled to the peak detector to receive the maximum absolute values, and for setting one of the testing operating voltages corresponding to a minimum one of the maximum absolute values as the operating voltage.

10. The flat panel display device according to claim 8, wherein the testing area further comprises a second testing pixel, the second testing pixel and the first testing pixel are electrically coupled to different ones of the scan lines while electrically coupled to receive a same display data voltage signal, the detecting circuit comprises:
a subtractor, comprising two input terminals, wherein one of the two input terminals is electrically coupled to the first testing pixel to receive the first data voltages, and the other one of the two input terminals is electrically coupled to the second testing pixel to receive corresponding second data voltages stored in the second testing pixel being charged effected by the testing operating voltages respectively;
a rectifier, wherein an input terminal of the rectifier is electrically coupled to an output terminal of the subtractor;
a peak detector, wherein an input terminal of the peak detector is electrically coupled to an output terminal of the rectifier, and an output terminal of the peak detector is for outputting maximum absolute values; and
a processing unit, electrically coupled to the peak detector to receive the maximum absolute values, and for setting one of the testing operating voltages corresponding to a minimum one of the maximum absolute values as the operating voltage.

11. The flat panel display device according to claim 8, wherein the detecting circuit comprises:
a voltage divider, electrically coupled to the data line which is electrically coupled with the first testing pixel, and for performing a voltage dividing operation applied to a display data voltage signal provided by the data line to thereby output a result of the voltage dividing operation;
a comparator, comprising two input terminals, wherein one of the two input terminals is electrically coupled to the first testing pixel to receive the first data voltages, the other one of the two input terminals is electrically coupled to the voltage divider to receive the result of the voltage dividing operation;
a peak detector, wherein an input terminal of the peak detector is electrically coupled to an output terminal of the comparator, and an output terminal of the peak detector is for outputting maximum absolute values respectively corresponding to the first data voltages; and
a processing unit, electrically coupled to the peak detector to receive the maximum absolute values, and for setting a bigger one or a smaller one from two of the testing operating voltages being with neighboring values and resulting in different ones of the maximum absolute values as the operating voltage.

12. The flat panel display device according to claim 8, wherein the first testing pixel comprises a switching unit, a display capacitor and a storage capacitor, a terminal of the display capacitor is electrically coupled to the switching unit and another terminal of the display capacitor is electrically coupled to a first common electrode, a terminal of the storage capacitor is electrically coupled to the switching unit and another terminal of the storage capacitor is electrically coupled to a second common electrode, the detecting circuit comprises:
a subtractor, comprising two input terminals, wherein one of the two input terminals is electrically coupled to the first testing pixel to receive the first data voltages, and the other one of the two input terminals is electrically coupled to the first or second common electrode;
an integrator, wherein an input terminal of the integrator is electrically coupled to an output terminal of the subtractor, and an output terminal of the integrator is for outputting integrating results respectively corresponding to the first data voltages; and
a processing unit, electrically coupled to the integrator to receive the integrating results, and for setting a bigger one or a smaller one from two of the testing operating voltages provided on the first or second common electrode being with neighboring values and resulting in different ones of the integrating results as the operating voltage.

13. The flat panel display device according to claim 12, wherein the detecting circuit further comprises:
a voltage limiter, electrically coupled between the integrator and the processing unit to perform maximum and minimum voltage limits for the integrating results outputted to the processing unit.

14. The flat panel display device according to claim 8, wherein the electronic device comprises a scan line driving circuit module for supplying voltage signals on the scan lines.

15. The flat panel display device according to claim 8, wherein the electronic device comprises a common voltage driving circuit module for supplying a common voltage to the pixels.
